(19) United States
(12) Patent Application Publication
(10) Pub. No.: US 2015/0095416 A1
(43) Pub. Date: Apr. 2, 2015

(54) TECHNIQUES FOR EMBEDDING MULTIMEDIA CONTENT WITH DEVICE IDENTIFICATION INFORMATION FOR DEVICES IN PROXIMITY

(71) Applicants: RONI ABIRI, Raanana (IL); TOMER DANIEL, Herzlyia (IL); ALEX ORENOV, Ashdod (IL)

(72) Inventors: RONI ABIRI, Raanana (IL); TOMER DANIEL, Herzlyia (IL); ALEX ORENOV, Ashdod (IL)

(21) Appl. No.: 14/039,839

(22) Filed: Sep. 27, 2013

(51) Int. Cl. H04L 29/08

(52) U.S. Cl. CPC H04L 67/1061
USPC 709/204

(57) ABSTRACT

Various embodiments are generally directed to an apparatus, method and other techniques for generating multimedia content based on received information, determining whether one or more devices are within a defined distance of the apparatus based on information received from the one or more devices and embedding device identification information for the one or more devices determined to be within the defined distance of the apparatus in the multimedia content.

### TECHNICAL FIELD

Embodiments described herein generally relate to embedding multimedia content with device identification information. More specifically, embodiments are directed to generating multimedia content by a computing device, determining other devices in proximity to the computing device and embedding the multimedia content with device identification information based on the devices in proximity to the computing device.

### BACKGROUND

With the advent of digital photography and video making, accumulation of thousands of images and videos is common. However, accumulating such large amounts of images and videos can become cumbersome and difficult to manage. In particular, browsing and choosing images to share with friends can become a time consuming task that users generally would like to avoid. A user may spend hours browsing through pictures and video to find a particular picture or video. In addition, users may spend large amounts of time organizing their pictures and videos so that they are more readily available and easy to find. In both cases, the user spends a large of amount time that could be better spent doing other tasks.

### BRIEF DESCRIPTION OF THE DRAWINGS

FIG. 1 illustrates an embodiment communication network system for detecting devices in proximity of a computing device.

FIG. 2 illustrates an embodiment of a first multimedia content embedding system.

FIG. 3 illustrates an embodiment of a first logic flow diagram for embedding multimedia content.

FIG. 4 illustrates an embodiment of a first process flow diagram for embedding multimedia content.

FIG. 5 illustrates an embodiment of a first logic flow diagram for filtering multimedia content.

FIG. 6 illustrates an embodiment of a display for recommendations for multimedia content.

FIG. 7 illustrates an embodiment of a display for filtering multimedia content.

FIG. 8 illustrates an embodiment of a second logic flow diagram for embedding multimedia content.

FIG. 9 illustrates an embodiment of a first computing architecture.

### DETAILED DESCRIPTION

Various embodiments are generally directed to generating multimedia content including one or more images and/or videos by a computing device and embedding the multimedia content with device identification information. The device identification information may be from other devices in proximity to the device generating the content at the time the content was created. For example, a user of a computing device such as a mobile telephone may be taking a picture of a group of friends. The computing device may determine other devices that are in proximity approximately while the picture is being taken. The computing device may receive location information from other devices, either directly or through one or more communications links. Once the multimedia content is generated the device identification information of the devices determined to be in proximity will be embedded in the multimedia content.

Further, embedding the multimedia content with the device identification information allows a user to quickly and efficiently filter multimedia content to search for a particular user's device or an account associated with the user. In addition, recommendations may be generated for particular multimedia content for sharing with other users based on the device identification information embedded in the multimedia content. These and other embodiments will become more apparent in the description that follows.

With general reference to notations and nomenclature used herein, the detailed description that follows may be presented in terms of program procedures executed on a computer or network of computers. These procedural descriptions and representations are used by those skilled in the art to most effectively convey the substance of their work to others skilled in the art.

A procedure is here and is generally conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein that form part of one or more embodiments. Rather, the operations are machine operations. Useful machines for performing operations of various embodiments include general-purpose digital computers or similar devices.

Various embodiments also relate to apparatus or systems for performing these operations. This apparatus may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

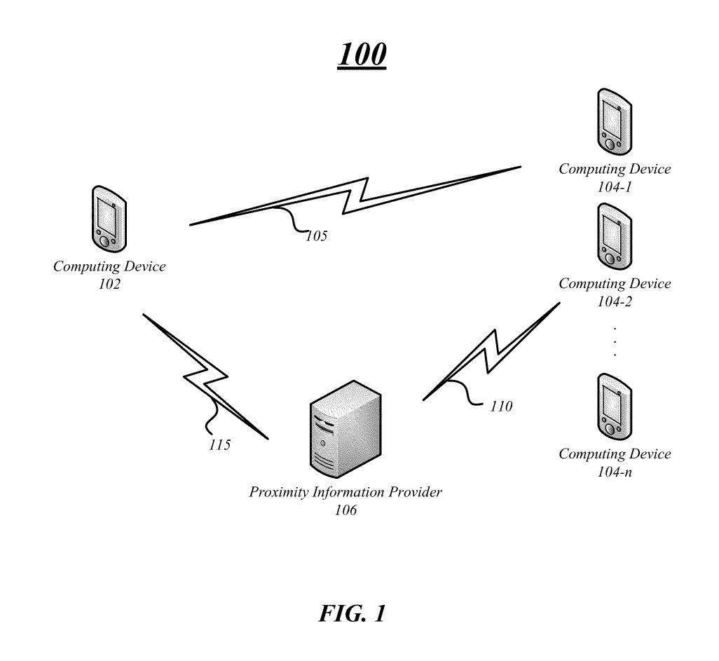

FIG. 1 illustrates an embodiment of an exemplary communication network system 100 for detecting one or more devices in proximity of a computing device and for implementing various embodiments described herein. In various embodiments, the communication network 100 includes a computing device 102, computing devices 104-n, and proximity information provider 106. The computing device 102, computing devices 104-n, and the proximity information provider 106 may communicate over any number of communications links, including communication links 105, 110 and 115. In various embodiments the communications links 105, 110 and 115 may be the same link or different links. Various embodiments are not limited in this manner. The network system 100 may include any number of devices, servers, and communications links to enable determining devices within proximity of another device and embedding device identification information in multimedia content as shown in FIG. 1.

Communication links 105, 110 and 115 may include any wired or wireless network links to provide communication to and from the computing device 102. In various embodiments, the communication links or portions thereof may be a secure communication link using various encryption methods to prevent data or information from being compromised. The communication links may include one or more apparatuses, devices, servers, databases, systems and circuitry for providing a communication link between the computing device 102 and the other system components, servers, processors, etc. The communication link may include one or more wireless network systems including a wireless local area network (WLAN) system, wireless metropolitan area network (WMAN) system, wireless wide area network (WWAN) system, and so forth. In addition, the communication links may communicate information in accordance with different types of shorter range wireless systems, such as a wireless personal area network (PAN) system. One example of a suitable wireless PAN system offering data communication services may include a Bluetooth system operating in accordance with the Bluetooth Special Interest Group (SIG) series of protocols. Other examples may include systems using infrared techniques or near-field communication techniques and protocols, such as electro-magnetic induction (EMI) techniques.

In various embodiments, computing devices 102 and 104-n may be any type of computing device including a mobile computing device including a personal computer (PC), laptop computer, ultra-laptop computer, netbook computer, ultrabook computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In some embodiments, computing devices 102 and 104-n may communicate any type of information with each other via one or more wired or wireless connections over communication link 105 using any communication protocol. For example, computing device 102 may receive device identification information and/or location information from one or more of the computing device 104-n. In some embodiments the computing devices 102 may send a request for the device identification information and location information and receive the information in response to the request. However, various embodiments are not limited in this manner and the computing device 102 may receive identification information or location information as broadcast message, for example.

Computing device 102 may also share or send multimedia content to one or more devices 104-n over communication link 105. As will be discussed in more detail below, computing device 102 may generate multimedia content and embed device identification information in the multimedia content. The multimedia content may then be shared with or sent to computing devices 104-n based on the device identification information. In some embodiments, the computing device 102 may share the multimedia content over one or more social networking accounts based on an association between device identification information and one or more of the social networking accounts. In addition, the computing device 102 may send or share the multimedia content with one or more of computing devices 104-n based on an association between the device identification information and a contact listing.

In various embodiments, system 100 may also include a proximity information provider 106. The proximity provider 106 may be one or more computing devices sending, receiving and storing device identification information based on a location of the one or more computing devices, such as computing devices 102 and 104-n. In various embodiments, the proximity provider 106 may include INTEL's® Common Connectivity Framework® or may be a 3rd-party device location information provider, such as GOOGLE LATITUDE®, YAHOO FIRE EAGLE®, BRIGHTKITE®, LOOPT®, MOBIFRIENDS®, TRIPIT®, DOPPLR®, etc.

In some embodiments, the computing device 102 may receive device identification information and location information from the proximity information provider 106 via communications link 115 for each of one or more computing device 104-n. The computing device 102 may receive the information in response to a request sent to the proximity provider 106 or as a broadcast message based on being logged into an account with proximity provider 106. In some embodiments, the computing device 102 may send its device identification information to the proximity provider 106.

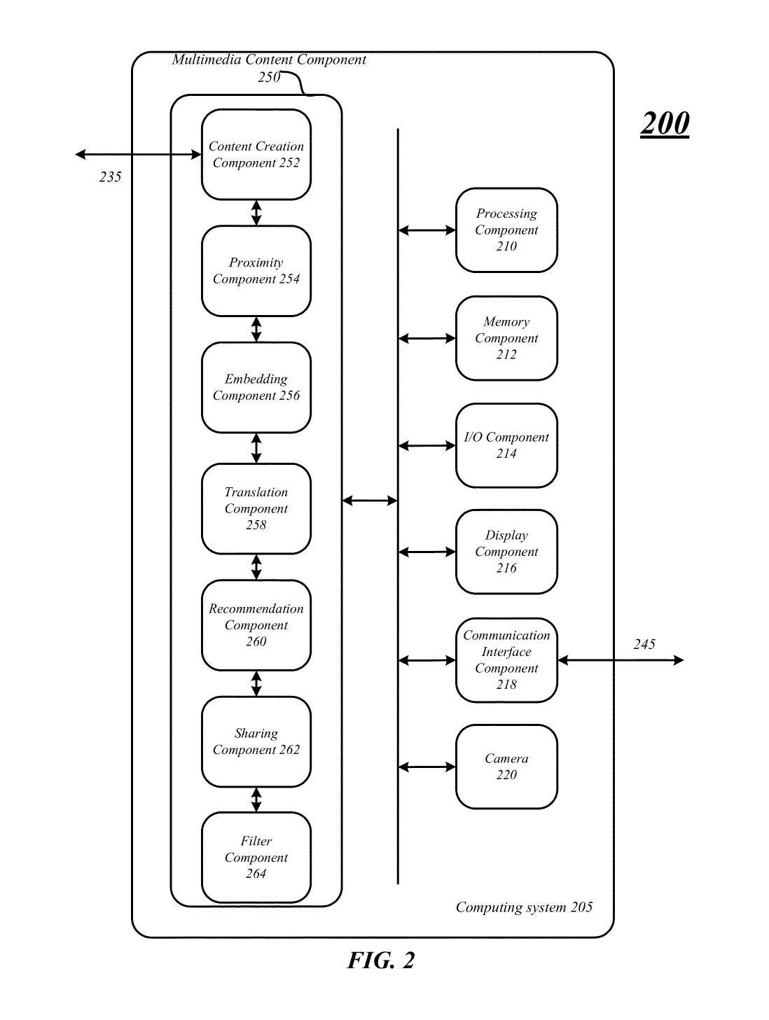

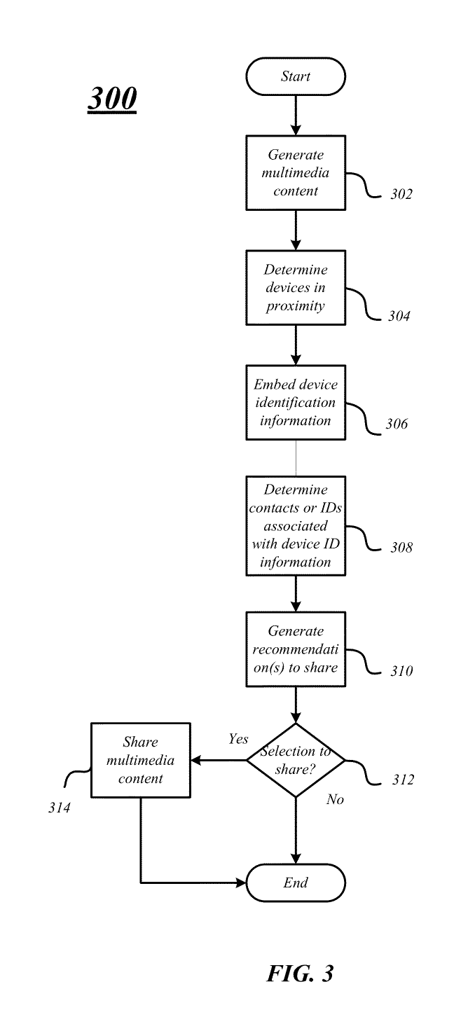

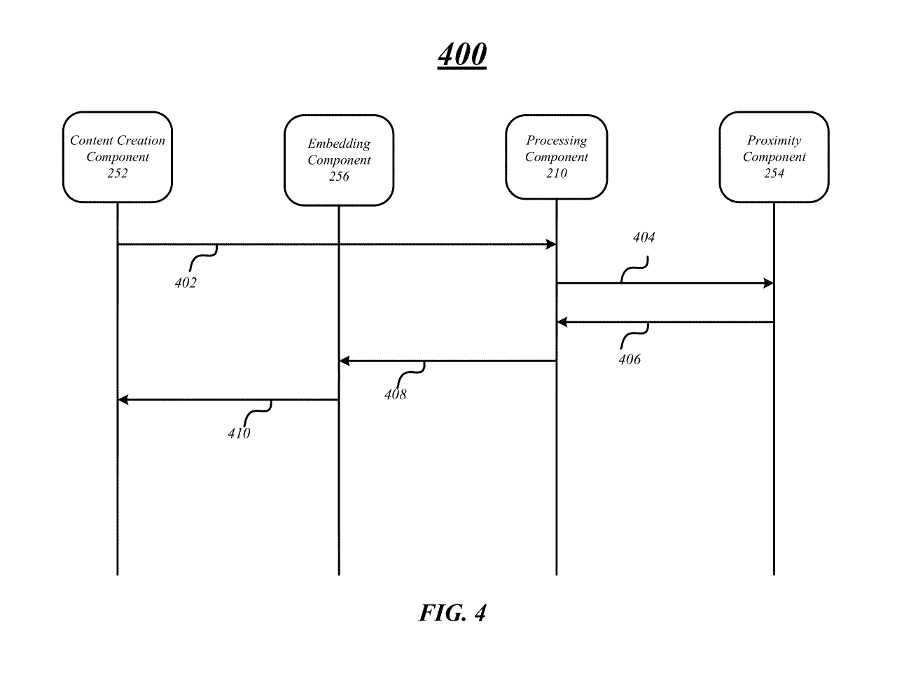

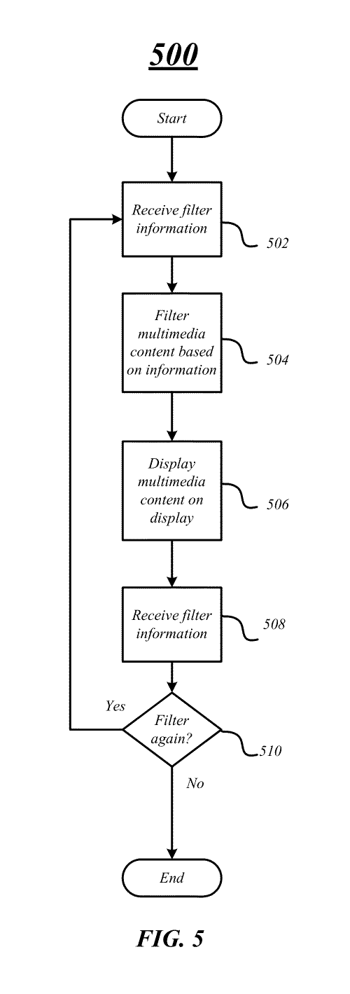

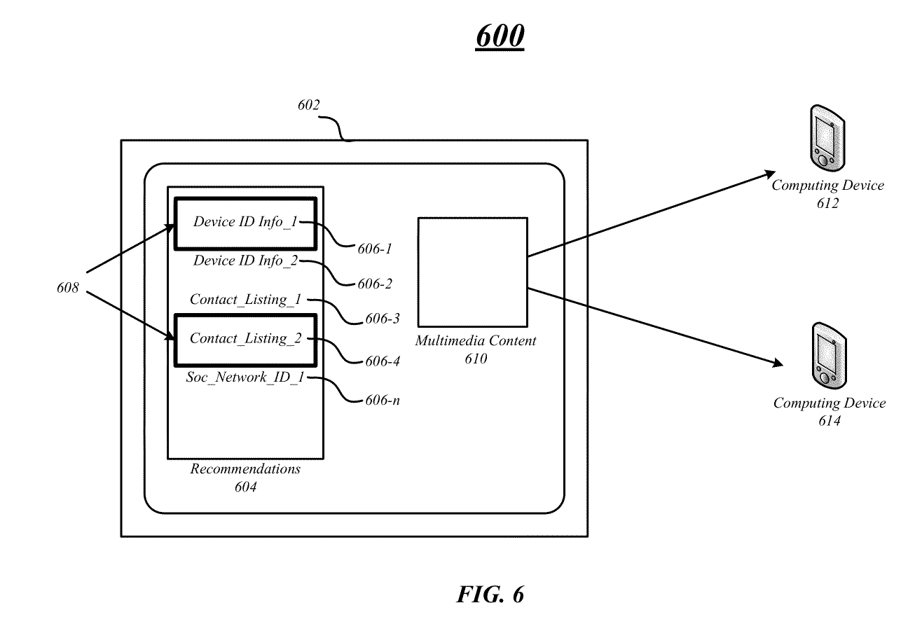

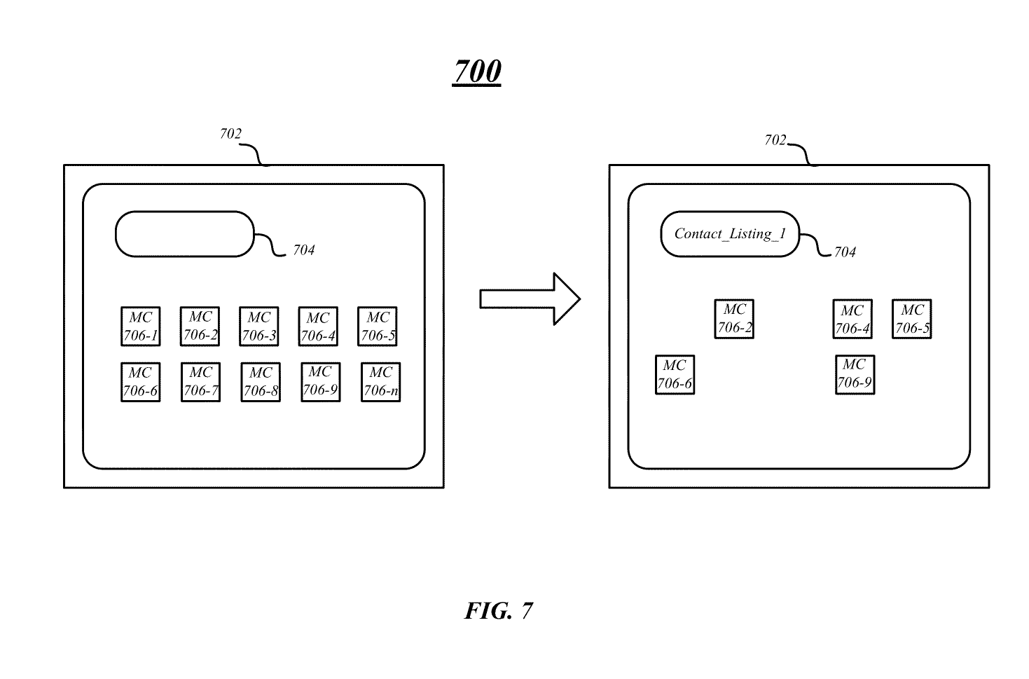

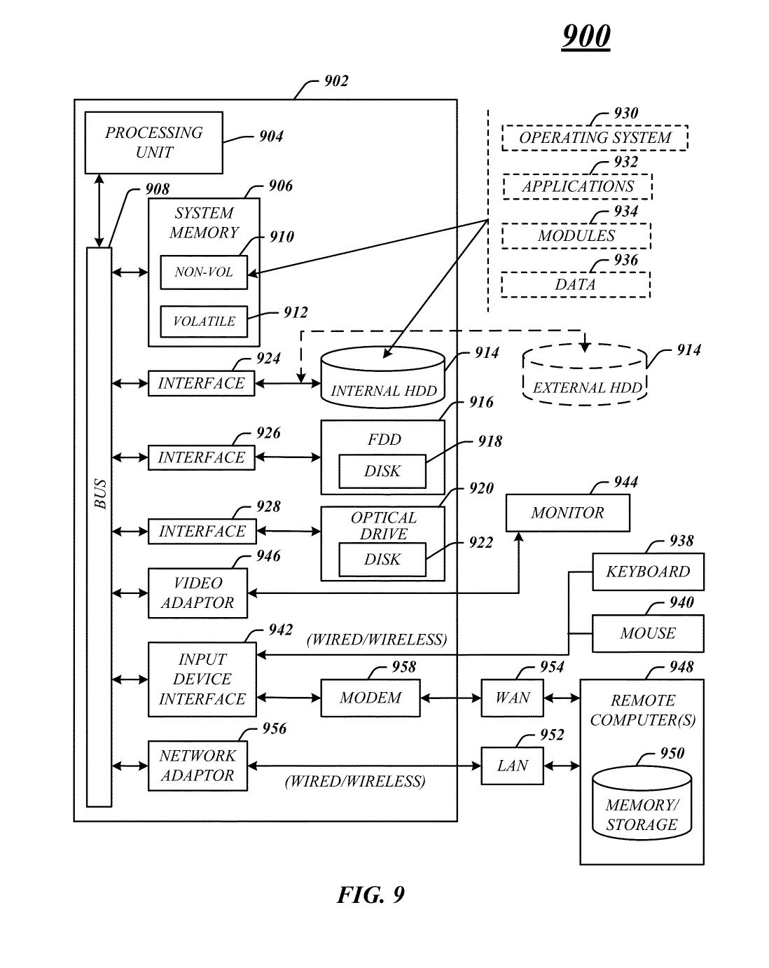

FIG. 2 illustrates one embodiment of a multimedia content embedding system 200, and in particular, computing device 205. In various embodiments, computing device 105 may be representative of a computing system suitable for use with one or more embodiments described herein, such as, logic flow 300 of FIG. 3, process flow 400 of FIG. 4, logic flow 500 of FIG. 5, display 600 of FIG. 6, display 700 of FIG. 7, and/or system 900 of FIG. 9.

In various embodiments, computing device 205 may be any type of computing device including a mobile computing device including a personal computer (PC), laptop computer, ultra-laptop computer, netbook computer, ultrabook computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context. In some embodiments, computing device 205 may also be a vehicle navigation system, vehicle infotainment system, embedded in home appliances, etc.

As shown in FIG. 2, computing device 205 may include multiple elements. One or more elements may be implemented using one or more circuits, components, registers, processors, software subroutine modules, or any combination thereof, as desired for a given set of design or performance constraints. Although FIG. 1 shows a limited number of elements in a certain topology by way of example, it can be appreciated that more or less elements in any suitable topology may be used in computing device 105 as desired for a given implementation. The embodiments are not limited in this context.

In various embodiments, computing device 205 may include a processing component 210. Processing component 210 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit or processor circuitry. The processing component 210 may be connected to and communicate with the other elements and components of the computing system via an interconnect 243, such as one or more buses, control lines, and data lines.

In one embodiment, computing device 205 may include a memory component 212 to couple to processing component 210. In various embodiments, the memory component 212 may store data and information for system 200. For example, the memory component 212 may store and maintain device identification information, contact information and multimedia content information, or any other type of information relating to embedding a list of device identifications, contact information, and/or social networking identification into multimedia content.

Memory component 212 may be coupled to processing component 210 via interconnect 243, or by a dedicated communications bus between processing component 210 and memory component 212, as desired for a given implementation. Memory component 212 may be implemented using any machine-readable or computer-readable media capable of storing data, including both volatile and non-volatile memory. In some embodiments, the machine-readable or computer-readable medium may include a non-transitory medium. The embodiments are not limited in this context.

The memory component 212 can store instructions and data momentarily, temporarily, or permanently. The memory component 212 may also store temporary variables or other intermediate information while the processing component 210 is executing instructions. The memory component 212 is not limited to storing the above discussed data and may store any type of data.

The computing device 205 may include input/output (I/O) component 214 having at least one of an input device or sensor, such as one or more buttons, a keyboard, a keypad, a touchscreen display, a touch sensitive device, a microphone, a biometric finger printer reader, biometric eye scanner or any other device used for inputting information into computing device 205. Moreover, the I/O component 214 may be a sensor including any hardware or logic to detect one or more touches or inputs on or near a housing of the apparatus, a display of the apparatus including a touchscreen display or touch sensitive display. The one or more inputs may occur separately, simultaneously and/or sequentially. The I/O component 214 monitors touches that occur on the housing or display and produces signals indicative thereof. In addition, the I/O component 214 may be used to input any information or data into the computing device 205.

In various embodiments, the I/O component 214 may include one or more components to output information to a user. For example, the I/O component 214 may include a speaker to output an audible noise or a haptic feedback device to output a vibration. The I/O component 214 may be located any within or on computing device 205, or may be separate and connected to the computing device 205 via a wired or wireless connection.

In embodiments, the computing device 205 may include a display component 216. Display component 216 may constitute any display device capable of displaying information received from processing component 210. The display component 216 may include at least one of a Liquid Crystal Display (LCD), a Thin Film Transistor-LCD (TFT-LCD), an Organic Light Emitting Diode (OLED), a flexible display, a three-dimensional (3D) display, touchscreen and/or touch sensitive display and a projector, for example. The display component 216 may display a User interface (UI) or a Graphical User Interface (GUI) associated with controlling functionality of the computing device 205. The computer device may include two or more display units, according to various embodiments. The display component 216 may display any information or data associated computing system 205.

In embodiments, the computing device 205 may include a communication interface component 218. The communication interface component 218 includes any device and circuitry for processing information or communications over wireless and wired connections. For example, the communication interface component 218 may include a transceiver, receiver, a transmitter, one or more antennas, and one or more Ethernet connections. The specific design and implementation of the communication interface component 218 may be dependent upon the communications network in which the computing device 205 is intended to operate. In some embodiments, the computing device 205 may be designed to operate in a plurality of communications networks and is not limited to a specific network.

In various embodiments, the communication interface component 218 may include one or more I/O controllers (not shown) to receive and output any signals and information. The I/O controller may enable communication over wireless and wired connections. In various embodiments, the I/O controller may be separate component or module of computing device 205.

The communication interface component 218 may enable the computing device 205 to communicate over one or more links including communications link 245 and communications links 105, 110 and 115, as shown in FIG. 1. For example, the communication interface component 218 may enable the computing device 205 to communicate information with the one more computing devices 104-n and proximity information provider 106 via communication link 245 and/or 105, 110 and 115. The information may be any data or information relating to the multimedia content embedding and sharing. In various embodiments, communication interface component 218 is not limited to communicating over network communication link 145 and may communicate over any communication link.

In various embodiments, computing device 205 includes a camera 220 and camera circuitry to capture, receive or detect image information. Camera 220 may be any type of camera including a still photo camera and/or a video camera capable of capturing image information. In various embodiments, the camera 220 may send the image or information to the other components of the computing device 205 for further processing, as will be explained in more detail below.

Computing device 205 may also include multimedia content component 250 for processing multimedia content. In various embodiments, the multimedia content component 250 includes one or components for proximity detection, multimedia content embedding and multimedia content sharing. In various embodiments, the multimedia content component 250 includes a content creation component 252, a proximity component 254, an embedding component 256, a translation component 258, a recommendation component 260, a sharing component 262 and a filter component 264. FIG. 2 illustrates the multimedia content component 250 having a limited number of components. However, various embodiments are not limited in this manner, the multimedia content component 250 may have any number of components to provide multimedia content processing capabilities.

In various embodiments, the content creation component 252 may generate multimedia content based on information received from one or more cameras. For example, the camera 220 may capture and/or generate image information and/or video information via one or more sensors within camera 220. The image information and/or video information may be processed by one or more components within the computing device 205 and the content creation component 252 may generate multimedia content based on the information received from the camera and other processing components.

The multimedia content may include one or more images and/or one or more videos. The multimedia content may be in any file format including, but not limited to, moving picture experts group (MPEG) formats, DivX, Xvid, H.264, MICROSOFT® formats, ON2® formats, REAL® Networks Video formats, and so forth. In some embodiments, the multimedia include may include one or more images in any image format including, but not limited to, Raster formats such as JPEG, Exif, TIFF, RAW, GIF, BMP, PNG, PPM, PAM, HDR Raster formats, Vector formats, Compound formats, Stereo formats, and so forth.

The content creation component 252 may provide or send the multimedia content to any of the other components for further processing via one or more interconnects 243. For example, the content creation component 252 may send the multimedia content to the embedding component 256 such that the embedding component may embed information within the multimedia content, as will be discussed in more detail below.

In some embodiments, the multimedia content component 250 may include a proximity component 254 to determine whether one or more devices are within a predetermined distance of the computing device 205 based on information received from the one or more devices. More specifically, the proximity component 254 may receive location information from one or more devices in proximity to the computing device and the proximity component 254 may determine a distance between the computing device 205 and the one or more other devices. In some embodiments, the proximity component 254 may receive the location via the communication interface component 218 over a direct connection between the computing device 205 and the other devices, through one or more intermediary devices such as network controllers and routers, and/or from the proximity service provider 106.

In addition, the defined distance may be any distance determined by a user as user configuration setting or a default setting. The defined distance may be in any distance measurement including feet, meters, yards, inches, kilometers, or any other distance measurement. For example, a user of the device may configure the defined distance at ten feet and any devices calculated to be within ten feet of the computing device will be considered to be within proximity of the computing device 105. The above-recited example should not be construed in a limiting manner and the defined distance may be any distance.

The proximity component 254 may determine the distance between each of the computing devices based on a known location of the computing device 205 and the location information received by the one or more other devices. The computing device 205 may calculate its own location based on any location technique known to one skilled in the art including utilizing a Global Position System (GPS), triangulation techniques, based on an internet protocol address (IP) or any other techniques. Further the other computing devices may determine their location in a similar manner as one known skilled in the art.

The proximity component 254 may determine distance between the computing device 205 and each of the other devices and a determination is made as to whether each of the other devices is within or at the defined distance. The proximity component 254 may decide to ignore devices outside of the defined distance and only information from the devices within the defined distance will be used for further processing.

In some embodiments, the proximity component 254 may send information for each of the devices determined to be within proximity of the computing device 205 to the embedding component 256. The information may include device identification information for each of the devices.

In various embodiments, the multimedia content component 250 may include an embedding component 256 to embed information in multimedia content. In various embodiments, the embedding component 256 may receive multimedia content from the content creation component 252 and information for each of one or more devices determined to be in proximity to the computing device 205. The embedding component 256 may embed the media content with the information including device identification information. In some embodiments, the embedding component 256 may embed the information as metadata or a tag within the media content. The information may be embedded in the multimedia content at the time the multimedia content is created or at a later time based on a time stamp and devices determined to be within proximity at the same time as the time stamp.

The embedding component 256 may also embed other information within the multimedia content as metadata or a tag. For example, the embedding component 256 may embed one or more contact listings and social networking identifications in the multimedia content. As will be discussed in more detail below, one or more contact listings, or social networking identifications may be determined based on the device identification information.

The computing device 205 may also include a translation component 258 to determine one or more contact listings and/or social networking identifications based on the device identification information. More specifically, the translation component 258 may look up in a table or listing in memory associations between device identification information for each of the one or more devices and contact listings or social networking identifications. In various embodiments, device identification information may be associated with one or more contact listings and social networking identifications. For example, device identification information for a device may be associated with a particular contact listing and a number of social networking identifications. A contacting listing may include any contact information found in a contact list of the computing device 105 including email addresses, messaging identifications, telephone number information, etc. The social networking identifications may include any identification for a social networking website such as, FACEBOOK®, GOOGLE®, YAHOO®, PINTEREST®, TWITTER®, LINKEDIN®, including photo sharing sites such as FLICKR®, PHOTOBUCKET®, SLICKPIC®, WEBSHOTS®, etc.

In some embodiments, the translation component 258 may permit or enable a user of the computing device 205 to associate one or more contact listings and/or social networking identifications with particular device identification information. For example, a user interface, such as a graphical user interface (GUI) may enable a user to select particular contacting listings and social networking identifications to associate with device identification information. The translation component 258 may also permit or enable a user to delete or modify an existing association.

In some embodiments, the translation component 258 may provide information such as association information to one or more of the other components of the computing system 205 for each of the devices determined to be in proximity of the computing device. The association information for each of the device identification information may include the device identification information and the associated contacting listing(s) and social networking identification(s). In one example, the translation component 258 may determine associated listings and identifications and send the association information to the embedding component 256 so that the embedding component 256 may embed the association (contact listings and/or social networking identifications) into the multimedia content. In another example, the translation component 258 may send association information to the recommendation component 260 such that the recommendation component 260 may generate recommendations for a user to share the multimedia content with.

The translation component 258 may also receive information including contact listings and social networking identifications from the filter component 264 to use to look up associated device identification information. The translation component 258 may determine the device identification information associated with the contacting listings and/or social networking identifications and send the device identification information to the filter component 264 for further processing.

The computing device 205 may include a recommendation component 260 to generate recommendations for sharing the multimedia content. The recommendation component 260 may generate a recommendation to share the multimedia content based on the device identification information, a contacting listing and/or a social networking identification. For example, the recommendation component 260 may receive the associated information from the translation component 258 and generate a list of contacting listings and/or social networking identifications to share the multimedia content with. The list of recommendations may include all of the contact listings and/or social networking identifications for each of the devices determined to be with in proximity of the computing device 205 and embedded in the multimedia content. In addition a separate listing for each of the devices in proximity may also be generated.

In various embodiments, the recommendation component 260 may present to the user on a display in a user interface or GUI the listing of recommendations. The user may then interact with the user interface to choose one or more of the recommendations to share or send the multimedia content information with. For example, a user may be presented a list of contact listings and social networking identifications such as a FACEBOOK contacts and TWITTER contacts to share the multimedia content with. The user may then select or choose all or particular listings and/or identifications to share with and the recommendation component 260 may then generate information based on the selected listings and/or identifications to send to the sharing component 262.

In one or more embodiments, the computing device 205 and multimedia content component 250 may include a sharing component 262 to send multimedia content to one or more devices and/or social networking accounts. In various embodiments, the sharing component 262 may receive information from the recommendation component 260 of which contact listings and social networking identifications to share or send the multimedia content to. The sharing component 262 component may send the multimedia content to the listings and identifications based on the information received. For example, the sharing component 262 may send multimedia content to a particular email address, to a device via a short messaging service (SMS) message or multimedia messaging service (MMS) message, and post the multimedia content on a wall of a FACEBOOK® contact based on the information received from the recommendation component 260. The sharing component 262 may share the multimedia content with any number of devices and accounts. In addition, the sharing component 260 may send or communicate the multimedia content to each of the selected listings and identifications via various communication means over one or more communications links such as communications links 105, 110 and 115.

The sharing component 262 may also share multimedia content based on information received from filter component 264. As will be described in more detail below, a user may filter multimedia content including one or more images and videos based on device identification, contact listings and social networking identifications. The sharing component 262 may then receive information including multimedia content to share with one or more devices and social networking accounts. Based on the information received from the filter component 264, the sharing component 262 may share the multimedia content with the devices and accounts.

As previously discussed, the computing device 205 may include a filter component 264 to filter multimedia content based on device identification information, contact listings and social networking identifications. For example, the computing device 205 and filter component 264 may present a user interface for a user to select one or more device identification information, contacting listings and social networking identifications to filter the multimedia content by. The filter component 264 may then filter or select the multimedia content having the selected information, listings and identification embedding within the content to present on a display or display device. For example, a user may select a contact listing for a particular friend and the filter component will generate a listing or graphical display of all the multimedia content associated with that particular contact listing based on the metadata or a tag embedded in the multimedia content.

In various embodiments, if a selection is based on contact listings and/or social networking identifications, the filter component 264 may select the multimedia content directly if the multimedia content has the listings or identifications embedded in the content. However, in some instances, the filter component 264 need to utilize the translation component 258 to determine device identification information associated with the listings and/or identifications. For example, the filter component 264 may send the translation component 258 information including listings and/or identifications to use to look up associated device identification information. The filter component 264 may then receive from the translation component 258 the device identification information and filter the multimedia content based on the received device identification information.

The filter component 264 may also permit or enable a user to select multimedia content filtered to send to the sharing component for sharing the multimedia content. For example, a user may filter multimedia content for a particular contact listing, social networking identification or device identification information and the filter component 264 may present all the multimedia content associated with the selected listing, identification or information on a display. The user may then select particular multimedia content including images and/or videos or all of the multimedia content to share with a device associated with the listing, identification, or information. The filter component 264 may send this information including the multimedia content and the contact listing, social identification or device identification information to send to the sharing component 262 and the sharing component 262 may send the multimedia content.

FIG. 3 illustrates an embodiment of a logic flow diagram 300 of one example for generating multimedia content and embedding information within the multimedia content. At block 302, multimedia content may be generated or created based on information received from one or more cameras. For example, the camera 220 may capture and/or generate image information and/or video information via one or more sensors within camera 220. The image information and/or video information may be processed by one or more components within the computing device 205 and the content creation component 252 may generate multimedia content based on the information received from the camera and other processing components. For example, a user of the computing device may take a picture of a group of friends via the camera 220 of the computing device 205, and the content creation component 252 may generate multimedia content based on the information generated by the camera when the picture was taken.

In various embodiments, the proximity component 254 may determine other computing devices within proximity of computing device 205 and store information from those other computing devices at block 304. The proximity component 254 may determine whether one or more devices are within a defined distance of the computing device 205 based on information received from the one or more devices. More specifically, the proximity component 254 may receive location information from one or more devices in proximity to the computing device and the proximity component 254 may determine a distance between the computing device 205 and the one or more other devices. In some embodiments, the proximity component 254 may receive the location via the communication interface component 218 over a direct connection between the computing device 205 and the other devices, through one or more intermediary devices such as network controllers and routers, and/or from the proximity service provider 106. The proximity component 254 may then make a determination as whether another computing device is within proximity based on whether the distance is greater than the defined distance.

In one example, the computing device 205 taken the picture at block 302 may receive information including device identification information and device location for each of one or more devices of the friends in the picture. In addition, the computing device 205 may receive information from other devices. The proximity component 254 may determine which devices are in proximity of the computing device 205 based on the defined distance. The computing device 205 may then store or retain information associated with the devices determined to be in proximity of the computing device 205.

Contact listings and social networking identifications associated with the device identification information for the devices within proximity of the computing device 205 may be determined at block 306. The information may be determined by the translation component 258 based on a look up in a table, a database and/or in memory.

At block 308, the embedding component 256 may embed the device identification information in the generated multimedia content. In one example, the device identification information may be embedded into the multimedia content as metadata or a tag. In various embodiments, the embedding component 256 may also embed contact listings and social network identifications associated with the device identification information in the generated multimedia content.

In various embodiments, one or more recommendations to share the generated multimedia content may be generated at block 310. For example, the recommendation component 260 may generate a recommendation to share the multimedia content based on the device identification information, a contacting listing and/or a social networking identification. The recommendation component 260 may receive associated information from the translation component 258 and generate a list or display of device identification information, contacting listings and/or social networking identification to share the multimedia content with. The list of recommendations may include all of the contact listings and/or social networking identification for each of the devices determined to be with in proximity of the computing device 205 and embedded in the multimedia content. In addition a separate listing for each of the devices in proximity may also be generated. The recommendations may be presented to the user and the user may select one or more of the contact listings and/or social networking identifications to share the multimedia content with at block 312.

If a user does not select any multimedia content information to share with a contact listing or social networking identification, the logic process 300 may end. However, if a user selects to share the multimedia content information with one or more of the, device identification information, contact listings and/or social networking identification, the computing device 205 including the sharing component 262 may share the multimedia content with the selected device associated with information, contact listings and/or social networking identification. The sharing component 262 may share the multimedia content with any number of devices and accounts. In addition, the sharing component 260 may send or communicate the multimedia content to each of the selected listings and identifications via various communication means over one or more communications links such as communications links 105, 110 and 115.

FIG. 4 illustrates a first process flow diagram 400 for embedding device identification information in multimedia content at line 402. In various embodiments, multimedia content may be generated by the content generation component 252. For example a user of the computing device may create an image or video via a camera. A request to determine devices within proximity of the computing device create the content may then be sent to the proximity component at line 404. The request may be sent directly from the content creation 252 to the proximity component 254 or via the processing component 210.

The proximity component 254 may then determine which other devices are in proximity to the device creating the multimedia content at line 252. The proximity component 254 may return the information containing device identification information for each of the devices within proximity of the generating device to the embedding component 256 or via the processing component 210 at line 408. The embedding component may then embed the multimedia content with the device identification information and return the multimedia content to the content creation component 252 or send the multimedia content to other components for processing at line 410.

FIG. 5 illustrates a second logic flow 500 for filtering media content. At block 502, the filtering component may receive filter information via one or more inputs generated by a user of the computing device 205. For example, the computing device 205 and filter component 264 may present a user interface for a user to select one or more of device identification information, contacting listings and social networking identifications to filter the multimedia content by. The filter component 264 may then filter or select the multimedia content having the selected information, listings and identification embedding within the content to present on a display or display device at block 504.

In some embodiments, the filter component 264 may display or present the multimedia content on a display to the user of the computing device 205 at block 506. In various embodiments, the user may then select all or particular multimedia content to share with the user determined by the filter at block 508. The multimedia content selected may then be shared with a user's device and/or account based on the filtering information as discussed above. At decision block 508, a user may select a different filter to select multimedia content by and the process 300 may repeat itself. However, the process 300 may exit if the user chooses not to filter the multimedia content again.

FIG. 6 illustrates an exemplary embodiment of a display diagram 600 for displaying recommendations to a user. More specifically, display diagram 600 includes a exemplary display 602 for displaying a recommendation list 604, recommendations 606-1 through 606-n, recommendation selections 608, multimedia content 610 and sharing computing devices 612 and 614.

As previously discussed, in one or more embodiments, the recommendations component 260 may present recommendations to a user for sharing multimedia content with computing devices and/or social networking accounts. In this exemplary embodiment, display 602 illustrates recommendations list 604 to the user. However, various embodiments are not limited in this manner and the recommendations may be presented in any manner to the user. Recommendations 606-1 through 606-n are presented to the user in a list format. Moreover recommendation 606-1 is a first device identification, recommendation 606-2 is a second device identification information, recommendation 606-3 is a first contact listing, recommendation 606-4 is a second contact listing and recommendation 606-n is a first social network identification.

The recommendation component 260 may generate the recommendation based on embedded information in a chosen or particular multimedia content 610. In some embodiments, the device identification information, contact listings and social networking identification may be embedded in the multimedia content. However, in some embodiments, the translation component 258 may be utilized to determine the contacting listings and social network identifications based on the multimedia content only having device identification information embedded in it.

A user may select one or more of the recommendations to share the multimedia content with. In this exemplary embodiment, the user has made selection 608 of the first device identification 606-1 and the second contact listing 606-4 to share the multimedia content with. The sharing module 262 may then receive this selection information from the recommendation component 260 and send or share the multimedia content 610 with the devices and/or account associated with the selection. As previously stated, the first device identification information 606-1 is selected and corresponds to device 612 and the second contact listing 606-4 is selected corresponding to device 614. The sharing component 262 may then send or share the multimedia content 610 with the devices 612 and 614 in any manner as previously described above.

FIG. 7 illustrates an exemplary display diagram 700 for filtering multimedia content on a computing system. In display 702 includes a text box 704 for entering information to filter by. In some embodiments, text box 704 may be presented to the user as a drop down menu, scroll through menu or any other means to present to the user information to select filtering by. Display 702 also includes multimedia content 706-1 through 706-n presented to the user. In some embodiments multimedia content 706-1 through 706-n may be all the multimedia content stored on the computing device.

In this exemplary embodiment, display 708 shows that a user has inputted via any input means to filter by a first contact listing. Once the user has entered information to filter the multimedia content by, the filtering component 264 may determine all the multimedia content associated with the information entered by the user. The filtering component 264 may make this determination based on the embedded information in each of the multimedia content 706-1 through 706-n. In this example, display 708 illustrates to the user that multimedia content 706-2, 706-4, 706-5, 706-6 and 706-9 is associated with the filtering information entered by the user. The filtering component 264 may limit the display to only present the associated multimedia content to the user.

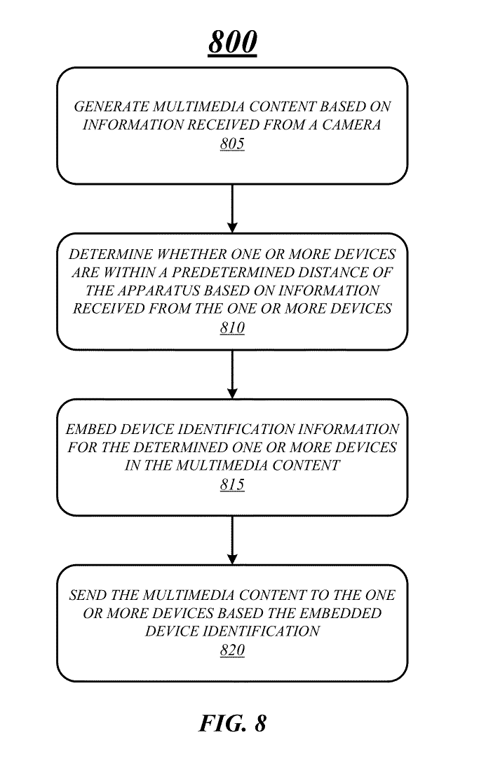

FIG. 8 illustrates an embodiment of a second logic flow 800 for embedding information in multimedia content. The logic flow 800 may be representative of some or all of the operations executed by one or more embodiments described herein. For example, the logic flow 800 may illustrate operations performed by the system 100 and 200.

In the illustrated embodiment shown in FIG. 8, the logic flow 800 may include generating multimedia content based on information received from a camera at block 805. For example, the camera 220 may capture and/or generate image information and/or video information via one or more sensors within camera 220. The image information and/or video information may be processed by one or more components within the computing device 205 and the content creation component 252 may generate multimedia content based on the information received from the camera and other processing components.

At block 810, the logic flow 800 may include determining whether one or more devices are within a defined distance of the apparatus based on information received from the one or more devices. More specifically, the proximity component 254 may receive location information from one or more devices in proximity to the computing device and the proximity component 254 may determine a distance between the computing device 205 and the one or more other devices. In some embodiments, the proximity component 254 may receive the location via the communication interface component 218 over a direct connection between the computing device 205 and the other devices, through one or more intermediary devices such as network controllers and routers, and/or from the proximity service provider 106.

In various embodiments, the logic flow 800 may also include embedding device identification information for the determined one or more devices in the multimedia content at block 815. In various embodiments, the embedding component 256 may receive multimedia content from the content creation component 252 and information for each of one or more devices determined to be in proximity to the computing device 205. The embedding component 256 may embed the media content with the information including device identification information. In some embodiments, the embedding component 256 may embed the information as metadata or a tag within the media content.

At block 820, the logic flow 800 may include sending the multimedia content to the one or more devices based on the embedded device identification information.

FIG. 9 illustrates an embodiment of an exemplary computing architecture 900 suitable for implementing various embodiments as previously described. In one embodiment, the computing architecture 900 may comprise or be implemented as part of computing device 205.

As used in this application, the terms “system” and “component” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 comprises a processing unit 904, a system memory 906 and a system bus 908. The processing unit 904 can be any of various commercially available processors, such as those described with reference to the processing component 210 shown in FIG. 2.

The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 900 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 906 can include non-volatile memory 910 and/or volatile memory 912. A basic input/output system (BIOS) can be stored in the non-volatile memory 910.

The computer 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936. In one embodiment, the one or more application programs 932, other program modules 934, and program data 936 can include, for example, the various applications and/or components of the system 100.

A user can enter commands and information into the computer 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A monitor 944 or other type of display device is also connected to the system bus 908 via an interface, such as a video adaptor 946. The monitor 944 may be internal or external to the computer 902. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the computing system 205 as previously described with reference to FIGS. 1-9 may comprise various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through forty (1-40) provided below are intended to be exemplary and non-limiting.

In a first example, an apparatus may include processor circuitry, a content creation component for execution on the processor circuitry to generate multimedia content based on information received from a camera, a proximity component for execution on the processor circuitry to determine whether one or more devices are within a defined distance of the apparatus based on information received from the one or more devices and an embedding component to be executed on the processor circuitry to embed device identification information for the one or more devices determined to be within the defined distance of the apparatus in the multimedia content.

In a second example and in furtherance of the first example, an apparatus may include a sharing component to send the multimedia content to the one or more devices based on the embedded device identification information.

In a third example and in furtherance of any of the previous examples, an apparatus may include a translation component to be executed on the processor circuitry to determine one or more contact listings and/or social networking identifications for at least one of the one or more devices based on the embedded device identification.

In a fourth example and in furtherance of any of the previous examples, an apparatus may include a recommendation component to be executed on the processor circuitry to generate a recommendation for sharing the multimedia content with one or more contact listings and/or social networking identifications and a sharing component to be executed on the processor circuitry to send the multimedia content to at least one of the one or more contact listings or social networking identifications based on an input.

In a fifth example and in furtherance of any of the previous examples, an apparatus may include a translation component to determine the one or more contact listings and/or social networking identifications based on an association between the device identification information and one or more of the contact listings and the social networking identifications.

In a sixth example and in furtherance of any of the previous examples, an apparatus may include a filter component for execution on the processor circuitry to filter the multimedia content based on a particular device identification, a contact listing or social networking identification and a display component to present the filtered multimedia content on a display.

In a seventh example and in furtherance of any of the previous examples, an apparatus may include an embedding component to embed the device identification information as metadata information in the multimedia content.

In an eighth example and in furtherance of any of the previous examples, an apparatus may include multimedia content including one or more image files and/or one or more video files, and the embedding component to embed the device identification information in each of the one or more image files and/or video files.

In a ninth example and in furtherance of any of the previous examples, an article may include an article comprising the computer-readable storage medium containing the plurality of instructions that when executed enable the computing device to generate multimedia content based on information received from a camera, determine whether one or more devices are within a defined distance of the apparatus based on information received from the one or more devices and embed device identification information for the one or more devices determined to be within the defined distance of the apparatus in the multimedia content.

In a tenth example and in furtherance of any of the previous examples, an article may include an article comprising the computer-readable storage medium containing the plurality of instructions that when executed enable the computing device to send the multimedia content to at least one of the one or more devices based on the embedded device identification information.

In an eleventh example and in furtherance of any of the previous examples, an article may include an article comprising the computer-readable storage medium containing the plurality of instructions that when executed enable the computing device to determine one or more contact listings and/or social networking identifications for at least one of the one or more devices based on the embedded device identification.

In a twelfth example and in furtherance of any of the previous examples, an article may include an article comprising the computer-readable storage medium containing the plurality of instructions that when executed enable the computing device to generate a recommendation for sharing the multimedia content with one or more contact listings and/or social networking identifications and send the multimedia content to at least one of the one or more contact listings or social networking identifications based on an input.

In a thirteenth example and in furtherance of any of the previous examples, an article may include an article comprising the computer-readable storage medium containing the plurality of instructions that when executed enable the computing device to determine the one or more contact listings and/or social networking identifications based on an association between the device identification information and one or more of the contact listings and the social networking identifications.

In a fourteenth example and in furtherance of any of the previous examples, an article may include an article comprising the computer-readable storage medium containing the plurality of instructions that when executed enable the computing device filter the multimedia content based on a particular device identification, a contact listing or social networking identification and present the filtered multimedia content on a display.

In a fifteenth example and in furtherance of any of the previous examples, an article may include an article comprising the computer-readable storage medium containing the plurality of instructions that when executed enable the computing device to embed the device identification information as metadata information in the multimedia content.

In a sixteenth example and in furtherance of any of the previous examples, the multimedia content including one or more image files and/or one or more video files, and the plurality of instructions that when executed enable the computing device to embed device identification information in each of the one or more image files and/or video files.

In a seventeenth example and in furtherance of any of the previous examples, a computer-implemented method may include generating multimedia content based on information received from a camera, determining whether one or more devices are within a defined distance of the apparatus based on information received from the one or more devices and embedding device identification information for the determined one or more devices in the multimedia content.

In an eighteenth example and in furtherance of any of the previous examples, a computer-implemented may include sending the multimedia content to the one or more devices based on the embedded device identification information.

In a nineteenth example and in furtherance of any of the previous examples, a computer-implemented may include determining one or more contact listings and/or social networking identifications for each of the one or more determined devices based on the embedded device identification.

In a twentieth example and in furtherance of any of the previous examples, a computer-implemented may include generating a recommendation for sharing the multimedia content with each of one or more contact listings and/or social networking identifications and sending the multimedia content to one or more contact listings or social networking identifications based on an input.

In a twenty-first example and in furtherance of any of the previous examples, a computer-implemented may include determining the one or more contact listings and/or social networking identifications based on an association between the device identification information and one or more of the contact listings and the social networking identifications.

In a twenty-second example and in furtherance of any of the previous examples, a computer-implemented may include embedding the device identification information as metadata information in the multimedia content.

In a twenty-third example and in furtherance of any of the previous examples, a computer-implemented may include embedding the device identification information as metadata information in the multimedia content.

In a twenty-fourth example and in furtherance of any of the previous examples, the multimedia content comprises one or more image files and/or one or more video files, and the computer-implemented method may include embedding the device identification information in each of the one or more image files and/or video files.

In a twenty-fifth example and in furtherance of any of the previous example, an apparatus may include means for generating multimedia content based on information received from a camera, means for determining whether one or more devices are within a defined distance of the apparatus based on information received from the one or more devices; and means for embedding device identification information for the determined one or more devices in the multimedia content.

In a twenty-sixth example and in furtherance of any of the previous example, an apparatus may include means for sending the multimedia content to the one or more devices based on the embedded device identification information.

In a twenty-seventh example and in furtherance of any of the previous example, an apparatus may include means for determining one or more contact listings and/or social networking identifications for each of the one or more determined devices based on the embedded device identification.

In a twenty-eighth example and in furtherance of any of the previous example, an apparatus may include means for generating a recommendation for sharing the multimedia content with each of one or more contact listings and/or social networking identifications; and means for sending the multimedia content to one or more contact listings or social networking identifications based on an input.

In a twenty-ninth example and in furtherance of any of the previous example, an apparatus may include means for determining the one or more contact listings and/or social networking identifications based on an association between the device identification information and one or more of the contact listings and the social networking identifications.

In a thirtieth example and in furtherance of any of the previous example, an apparatus may include means for filtering the multimedia content based on a particular device identification, a contact listing or social networking identification; and means for presenting the filtered multimedia content on a display.

In a thirty-first example and in furtherance of any of the previous example, an apparatus may include means for embedding the device identification information as metadata information in the multimedia content.

In a thirty-second example and in furtherance of any of the previous example, multimedia content may include one or more image files and/or one or more video files and an apparatus may include means for embedding the device identification information in each of the one or more image files and/or video files.

In a thirty-third example and in furtherance of any of the previous example, a system may include a transceiver, one or more antennas, memory, processor circuitry; and logic to be executed on the processor circuitry to generate multimedia content based on received information, determine whether one or more devices are within a defined distance of the apparatus based on information received from the one or more devices and embed device identification information for the one or more devices determined to be within the defined distance of the apparatus in the multimedia content.

In a thirty-fourth example and in furtherance of any of the previous example, a system may include logic to send the multimedia content to the one or more devices based on the embedded device identification information.

In a thirty-fifth example and in furtherance of any of the previous example, a system may include logic to determine one or more contact listings and/or social networking identifications for at least one of the one or more devices based on the embedded device identification.

In a thirty-sixth example and in furtherance of any of the previous example, a system may include logic to generate a recommendation for sharing the multimedia content with one or more contact listings and/or social networking identifications and send the multimedia content to at least one of the one or more contact listings or social networking identifications based on an input.

In a thirty-seventh example and in furtherance of any of the previous example, a system may include logic to determine the one or more contact listings and/or social networking identifications based on an association between the device identification information and one or more of the contact listings and the social networking identifications.

In a thirty-eighth example and in furtherance of any of the previous example, a system may include logic to filter the multimedia content based on a particular device identification, a contact listing or social networking identification and the system may include a display component to present the filtered multimedia content on a display.

In a thirty-ninth example and in furtherance of any of the previous example, a system may include logic to embed the device identification information as metadata information in the multimedia content.

In a fortieth example and in furtherance of any of the previous example, a system may include logic to process multimedia content including one or more image files and/or one or more video files, and the embedding component to embed the device identification information in each of the one or more image files and/or video files.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
processor circuitry;
a content creation component to be executed on the processor circuitry to generate multimedia content based on received information;
a proximity component to be executed on the processor circuitry to determine whether one or more devices are within a defined distance of the apparatus based on information received from the one or more devices; and
an embedding component to be executed on the processor circuitry to embed device identification information for the one or more devices determined to be within the defined distance of the apparatus in the multimedia content.

2. The apparatus of claim 1, comprising:
a sharing component to be executed on the processor circuitry to send the multimedia content to the one or more devices based on the embedded device identification information.

3. The apparatus of claim 1, comprising:
a translation component to be executed on the processor circuitry to determine one or more contact listings and/or social networking identifications for at least one of the one or more devices based on the embedded device identification.

4. The apparatus of claim 1, comprising:
a recommendation component to be executed on the processor circuitry to generate a recommendation for sharing the multimedia content with one or more contact listings and/or social networking identifications; and
a sharing component to be executed on the processor circuitry to send the multimedia content to at least one of the one or more contact listings or social networking identifications based on an input.

5. The apparatus of claim 3, the translation component to determine the one or more contact listings and/or social networking identifications based on an association between the device identification information and one or more of the contact listings and the social networking identifications.

6. The apparatus of claim 1, comprising:
a filter component to be executed on the processor circuitry to filter the multimedia content based on a particular device identification, a contact listing or social networking identification; and
a display component to present the filtered multimedia content on a display.

7. The apparatus of claim 1, the embedding component to embed the device identification information as metadata information in the multimedia content.

8. The apparatus of claim 1, wherein the multimedia content comprises one or more image files and/or one or more video files, and the embedding component to embed the device identification information in each of the one or more image files and/or video files.

9. An article comprising a computer-readable storage medium containing a plurality of instructions that when executed enable a computing device to:
generate multimedia content based on received information;
determine whether one or more devices are within a defined distance of the apparatus based on information received from the one or more devices; and
embed device identification information for the one or more devices determined to be within the defined distance of the apparatus in the multimedia content.

10. The article of claim 9, comprising the computer-readable storage medium containing the plurality of instructions that when executed enable the computing device to send the multimedia content to at least one of the one or more devices based on the embedded device identification information.

11. The article of claim 9, comprising the computer-readable storage medium containing the plurality of instructions that when executed enable the computing device to determine one or more contact listings and/or social networking identifications for at least one of the one or more devices based on the embedded device identification.

12. The article of claim 9, comprising the computer-readable storage medium containing the plurality of instructions that when executed enable the computing device to:
generate a recommendation for sharing the multimedia content with one or more contact listings and/or social networking identifications; and
send the multimedia content to at least one of the one or more contact listings or social networking identifications based on an input.

13. The article of claim 11, comprising the computer-readable storage medium containing the plurality of instructions that when executed enable the computing device to determine the one or more contact listings and/or social networking identifications based on an association between the device identification information and one or more of the contact listings and the social networking identifications.

14. The article of claim 9, comprising the computer-readable storage medium containing the plurality of instructions that when executed enable the computing device to:
filter the multimedia content based on a particular device identification, a contact listing or social networking identification; and
present the filtered multimedia content on a display.

15. The article of claim 9, comprising the computer-readable storage medium containing the plurality of instructions that when executed enable the computing device to embed the device identification information as metadata information in the multimedia content.

16. The article of claim 9, wherein the multimedia content comprises one or more image files and/or one or more video files, and the plurality of instructions that when executed enable the computing device to embed device identification information in each of the one or more image files and/or video files.

17. A system, comprising:
a transceiver;
one or more antennas;
memory;
processor circuitry; and
logic to be executed on the processor circuitry to generate multimedia content based on received information, determine whether one or more devices are within a defined distance of the apparatus based on information received from the one or more devices and embed device identification information for the one or more devices determined to be within the defined distance of the apparatus in the multimedia content.

18. The system of claim 17, the logic to send the multimedia content to the one or more devices based on the embedded device identification information.

19. The system of claim 17, the logic to determine one or more contact listings and/or social networking identifications for at least one of the one or more devices based on the embedded device identification.

20. The system of claim 17, the logic to generate a recommendation for sharing the multimedia content with one or more contact listings and/or social networking identifications and send the multimedia content to at least one of the one or more contact listings or social networking identifications based on an input.

21. The system of claim 19, the logic to determine the one or more contact listings and/or social networking identifications based on an association between the device identification information and one or more of the contact listings and the social networking identifications.

22. The system of claim 17, the logic to filter the multimedia content based on a particular device identification, a contact listing or social networking identification; and system comprising a display component to present the filtered multimedia content on a display.

23. The system of claim 17, the logic to embed the device identification information as metadata information in the multimedia content.

24. The system of claim 17, wherein the multimedia content comprises one or more image files and/or one or more video files, and the embedding component to embed the device identification information in each of the one or more image files and/or video files.
